(19) United States
(12) Patent Application Publication
(10) Pub. No.: US 2012/0182726 A1
(43) Pub. Date: Jul. 19, 2012

(54) CLIP-ON LED LAMP WITH SOLAR PANEL FOR BASEBALL CAP

(76) Inventor: GRACE KING, Whitestone, NY (US)

(21) Appl. No.: 13/347,035

(22) Filed: Jan. 10, 2012

Related U.S. Application Data
(60) Provisional application No. 61/461,014, filed on Jan. 12, 2011.

(51) Int. Cl. F21L 4/02; F21V 21/088; F21L 4/04

(52) U.S. Cl. 362/183; 362/191

(57) ABSTRACT

A clip type lamp attachable to a hat or cap. The clip type lamp comprises a housing including a main body, a solar panel on the top side of the main body, a plurality of light emitters on a rotating member configured to rotate about a horizontal axis of rotation at the front of the housing. A mode-control switch is provided on the exterior of the housing. The main body of the housing includes an interior chamber below the solar panel for receiving a solar-rechargeable battery. A clip extending under the bottom side of the housing may have one end integrally engaged with the housing or a forward extension thereof. The rotating member can be user-rotated so that at least one of the plurality of light emitters illuminates the user's face.

### CLAIM OF PRIORITY

This application claims the benefit and priority of U.S. Provisional Application No. 61/461,014, filed Jan. 12, 2011 which is hereby incorporated by reference herein.

### FIELD OF THE INVENTION

Exemplary embodiments of the invention relate to lamps for mounting on caps and hats, and more particularly, to a rotatable solar-charged lamp mountable on the brim of a hat such as baseball cap, a hardhat, a firefighter helmet, a jungle hat, a military helmet and a sports helmet.

### DESCRIPTION OF RELATED ART

The need for hands-free personal lighting devices has led to a variety of inventions. The range of head mounted lamp inventions includes the classic “miners hat”, the old style carbide lamp mounted on miners' hard hats. These inventions were precipitated by the need to illuminate a wide variety of human activities while keeping ones hands free for other uses. These activities include everyday occurrences such as reading a newspaper or reading product instructions or prescriptions in darkness, lighting ones pathway outdoors or illuminating the keyhole of a door lock; lighting a work space such as under the hood of a car while changing a spark plug or tightening a belt; or for lighting during a recreational activity such as illuminating a handhold or recess for a rock climber or illuminating the reel and pole in the hands of a night fisherman; and emergency situations such as changing a tire at night or resetting a tripped circuit breaker in a blackened basement. FIG. 1A, FIG. 1B and FIG. 1C are illustrations of head-worn forward-illumination lamps of the prior art.

For example, U.S. Pat. No. 4,298,913, incorporated by reference herein, is discloses a clip-on analog of the minor's lamp, mounted on the rim of the bill of a “hard hat” for providing forward illumination where hard hats are needed, such as construction sites and while spelunking.

LEDs have become available that output visible white light that is suitable in color and intensity and energy efficiency to be featured as the light emitter of a battery-powered head-worn forward illumination lamps and other portable devices. A light-emitting diode (LED) is a semiconductor device that emits light when electrically biased in the forward direction. The LED semiconducting chip is typically encased in a solid plastic lens, which is much tougher than the glass envelope of a traditional light bulb. The color of the emitted light depends on the chemical composition of the semiconducting material used, and/or of any “phosphor” coatings, and can be near-ultraviolet, visible or infrared. LEDs offer benefits in terms of maintenance and safety. The typical working lifetime of a device, including the bulb, is ten years, which is much longer than the lifetimes of most other light sources. Further, LEDs fail by dimming over time, rather than the abrupt burn-out of incandescent bulbs. LEDs give off less heat than incandescent light bulbs and are less fragile than fluorescent lamps.

An LED is a special type of semiconductor diode. Like a normal semiconductor diode, it consists of a chip of semiconducting material impregnated, or doped, with impurities to create a structure called a p-n junction. Charge-carriers-electrons and holes flow into the junction from electrodes with different voltages. When an electron meets a hole, it falls into a lower energy level, and releases energy in the form of a photon as it does so. LEDs require a DC supply of the correct electrical polarity. When the voltage across the p-n junction is in the correct direction, a significant current flows and the device is said to be forward-biased. If the voltage is of the wrong polarity, the device is said to be reverse biased, very little current flows, and no light is emitted, and can be damaged by an applied reverse voltage of more than a few volts.

The related art provides three general types of head-worn lamps. Those which are mounted directly to the head (e.g., by straps around the circumference of the head), those which are clip-on lamps (e.g., manufactured and sold separately from the baseball cap itself) for mounting on a hat (or on glasses) and those which are combination cap-lamp inventions in which the lamp circuitry is manufactured as part of the hat or is embedded within the material of the cap. Many of the combination cap-lamp inventions depend on a custom caps containing (and concealing) the lamp and power source and the wires connecting between them. Given the ubiquity of the common baseball style cap, inventions that couple a forward illumination lamp with a baseball cap in an useful manner generally provide functional hands-free lighting with a cap style acceptable to a broad diversity of people and circumstances.

Many of these inventions provide only fixed-direction light beams the angle of which may be suited for some human activities, but not for other human activities. For example, a combined lamp-baseball-cap invention titled “Headgear with Forward Illumination” (U.S. Pat. No. 7,234,831 and U.S. Pat. No. 7,086,749) provides an array of contiguous light emitting diodes integral within the brim of a baseball cap. And, for example, a clip-on lamp titled “Led Cap Light” (U.S. Pat. No. 7,506,992), incorporated by reference herein, provides an array of light emitting diodes that are fixed for forward illumination. These and similar inventions may facilitate walking on a dark path, but may not provide optimal illumination for reading or for close-up work, or for seeing to adjust clothing or gear worn on the front of one's body. Nor do these fixed-beam lamp-hats generally provide the user with the option to use the available light and available power to illuminate his or her own face, which may be important to the user or to others in certain contexts.

Further, many head-worn lamps rely upon disposable chemical batteries (e.g., AAA, AA cells) as their power source, and thus even when they are not in use, the battery contained in the lamp/cap may loose its charge and even corrode inside the lamp/cap over time, and thus the lamp/cap may be found to be non-functional at the time when it is most needed (e.g., during a emergency such as a mains power outage). The battery discharge-during-nonuse result may be postponed but not entirely avoided by incorporating larger-capacity, heavier batteries, within the lamp/cap but the added weight or bulk of this partial solution generally causes greater discomfort for the wearer.

This disappointing result is even more certain to occur when the circuitry, LEDs and/or batteries in the combination lamp-cap are so well concealed by its manufacturer that a forgetful user or someone else in the user's household mistakenly believes that the lamp-cap should be washed by immersion in soapy water (e.g., thrown into a washing machine) when it becomes soiled, stained, or adversely scented. Another recent U.S. Pat. No. ______, marketed as C.U.B. (Concealed Under Brim) Technology™, by ______ (inventor) ______, discloses such combination of LED lamps integrated into the brim of a baseball cap providing only illumination in the fixed forward direction and in a fixed downwardly-forward angle, with no protection from stray light from high-brightness LEDs for eyes of the user.

A removable forward illumination lamp for clipping on under the brim of a baseball cap is disclosed by inventor Dae Up Sohn in U.S. Pat. No. 7,118,241, incorporated by reference herein. A similar removable forward illumination lamp for clipping-on under the brim of a baseball cap, with a detachable solar panel positioned over the brim is disclosed by the same inventor, in U.S. Pat. No. 7,427,149, incorporated by reference herein. These under-the-brim clip-on lamps provide only fixed forward illumination, and potentially reduce the wearer's upward field of vision. Also, the detachable solar panel taught in U.S. Pat. No. 7,427,149 is not solidly connected to the fixed forward illumination lamp mounted under the brim and thus may be unintentionally separated, lost and/or discarded. Further, the provision of a hard shell case for support and/or protection of the edges and underside of the detachable solar panel while providing a hard casing for the top of the fixed forward illumination lamp mounted under the brim requires material adding weight to the assembly and increasing the material cost for manufacturing. Furthermore, the surface area and energy-collection capacity of the solar panel (within a given period of time) is also limited (substantially less than the full width of the lamp) to avoid collision or interference with the clips which are formed to be disposed on top of the brim on either side of the solar panel. This dimensional limitation of the solar panel's area relative the dimensions of the lamp's housing limits the power-harvesting capacity of the solar panel in a given period of time, and thus limits the brightness of the LEDs that can be practically employed in the lamp and/or limits the time interval during which the LEDs can be reliably expected to provide illumination based on a given solar charge time interval.

### SUMMARY OF THE INVENTION

An aspect of the invention provides a clip-on adjustable-direction illuminating lamp having an integrated solar panel serving as its upper casing, and a solar rechargeable battery, and a rotating light-emitting diode unit having a horizontal axis of rotation, with fasteners (e.g., plastic or metal clips, pins, etc.) for removably mounting the lamp on the front and upper side of the brim of a baseball cap or hard-hat or other edge.

Another aspect of the invention provides a clip type light emitter capable of detachably engaging to a hat or cap (including a leisure cap generally used for a mountain climbing or fishing or travel or various sports). The clip type light emitter comprises a housing including a main body, a solar panel integrated in the top side of the main body, a plurality of light emitters fixed on a rotating member configured to rotate about a horizontal axis of rotation at the front of the housing. Each of the plurality of light emitters has an axis or rotation, which may be “fanned out” and/or distributed along an arc. One, some, or all of the axes of rotation of the plurality of light emitters may be disposed above (not intersecting) the horizontal axis of rotation. A mode-control switch is provided on the exterior of the housing. The main body of the housing includes an interior chamber for receiving a solar-rechargeable battery. A clip extending under the bottom side of the housing may have one end integrally engaged with the housing or a forward extension thereof.

Various embodiments of the invention can be removably attached to a baseball cap at one time and to a hard hat at another time. For the sake of clarifying terminology used herein, a baseball cap 800 (see FIG. 2) comprises a crown 800-1 having a lower edge and a brim 800-2 disposed on the crown proximate to the lower edge of the crown. The brim 800-2 has a rim 800-3 disposed along the perimeter of the brim distal from the lower edge of the crown 800-1. The brim 800-2 of a baseball cap typically as an arch or curve as viewed from the front. The front edge of rim may be straight or curved. Similarly, a hard hat 900 (see FIGS. 1A and 3) comprises a crown 900-1 having a lower edge and a brim 900-2 disposed on the crown proximate to the lower edge of the crown. The brim 900-2 has a rim 900-3 disposed along the perimeter of the brim distal from the lower edge of the crown 900-1. However, the brim 800-2 of a hard hat may be flat (not arched or curved) as viewed from the front. Some embodiments of the invention are specially adapted to fit the flat brim of a hard hat. Some embodiments of the invention are specially adapted (e.g., having an arcuate contour) to fit the curved brim of a baseball cap. Exemplary embodiments of the invention provide a lamp for detachable engagement with a brim of a hat, comprising: a housing including a main body having a front side, and a top side including a photovoltaic (PV) panel, and a bottom surface, wherein the PV panel is configured for charging a rechargeable battery; a first hinge on the front side of the housing and having a horizontal axis of rotation; a first rotatable member, including a first light emitter having a first optical axis, that rotates about the horizontal axis of rotation (HAoR); a chamber in the main body of the housing for containing the rechargeable battery; a first switch for controlling the first light emitter configured to be connected in series between the rechargeable battery and the first light emitter; and a fastener (e.g., plastic or metal clips, pins, etc.) for removably attaching the lamp to the top surface of the brim of the hat. The first light emitter is preferably a light emitting diode (LED) and includes a lens. The first light emitter may have a reflector centered around its optical axis. The optical axis of the first light emitter may not intersect the HAoR, and is preferably disposed above the HAoR. Thus, while the first optical axis is (rotated) horizontal the first optical axis may be in a horizontal plane higher than the horizontal plane containing the HAoR. The first optical axis may be approximately 0.25 inches higher than the horizontal plane containing the HAoR in a various embodiments. In various embodiments, the HAoR is in a horizontal plane below the top plane of the solar panel. In various embodiments, while the first optical axis is horizontal the first optical axis is above the HAoR and below the solar panel.

The HAoR is preferably at least 4 millimeters forward of the end of the clip engaged with the housing (e.g., placing the HAoR forward of the front edge of the brim).

The first light emitter rotates about the HAoR and may be rotated to illuminate the face of a user. The HAoR is preferably at least 4 millimeters and at most 6 centimeters forward of the forward edge of the PV panel. The rotating member may be shaped such that the HAoR contains at least one point within 1 millimeter of bottom surface of the rotating member.

The first the first light emitter may be one of an ultraviolet (UV) light-emitting diode (LED) or an infrared (IR) light-emitting diode (LED).

The lamp preferably will further comprise a mode-selection switch configured to control the ON/OFF state of the first switch, and the first switch may be a field effect transistor (FET). The lamp may further comprise an integrated circuit including the first switch, wherein the mode-selection switch is connected to the control gate of first switch through the integrated circuit. In various embodiments, the lamp may further comprise a second light emitter fixed in the rotatable member and having a second optical axis.

The second optical axis may be not parallel to the first optical axis first light emitter The optical axis and second optical axis may diverge while they are in the same plane, so that they are not parallel with each other. The second light emitter having a second optical axis may be configured to rotate about the HAoR independently of the rotation of the first light emitter about the HAoR. A second switch may be provided for controlling the second light emitter configured to be connected in series between the rechargeable battery and the second light emitter, wherein the mode-selection switch is configured to control the ON/OFF state of the second switch. The mode-selection switch may be connected through the integrated circuit to the control gate of first switch and to the control gate of the second switch. The integrated circuit may include the first switch and the second switch. The hinge may include a first hollow hinge pin and wires connected in series with the first light emitter extend through a passage through the first hollow hinge pin.

A user of said lamp can attach exemplary embodiments of the lamp to the brim of the hat by pushing and can remove the lamp from the brim by applying a pulling force greater than a static friction force. The fastener may be an elastic clip engaged with the housing extending below the bottom surface of the housing for applying a force to the bottom surface of the brim of the hat. The clip may have one end integrally engaged with the housing. The fastener may be a clip formed of an elastic material and configured to provide force to a bottom surface of the brim and to develop a static friction force upon engagement with the brim. The clip formed of an elastic material may elastically deform to receive said brim between said clip and said housing. The elastic clip may comprise or consist essentially of spring steel.

The invention will now be described more fully with reference to the accompanying drawings in which some exemplary embodiments of the invention are shown. Detailed illustrative embodiments are disclosed herein. However, specific structural and functional details disclosed herein are merely representative for purposes of describing exemplary embodiments of the invention. This invention, however, may be embodied in alternate forms and should not be construed as limited to only the exemplary embodiments of the invention set forth herein.

Accordingly, while exemplary embodiments of the invention are capable of various modifications and alternative forms, embodiments thereof are shown by way of example in the drawings and will herein be described in detail. It should be understood, however, that there is no intent to limit exemplary embodiments of the invention to the particular forms disclosed, but on the contrary, exemplary embodiments of the invention are to cover all modifications, equivalents, and alternatives falling within the scope of the claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of exemplary embodiments of the invention. As used herein, the singular forms “a,” “an” and “the” are intended to include the plural forms as well, unless the context clearly indicates otherwise.

In order to more completely describe exemplary embodiments of the invention, various aspects of exemplary embodiments will be described in detail with reference to the attached drawings. However, the invention is not limited to exemplary embodiments of the invention described. Like numbers refer to like elements throughout the description of the figures.

### BRIEF DESCRIPTION OF THE DRAWINGS

Exemplary embodiments of the invention are described in further detail below with reference to the accompanying drawings, in which:

FIG. 1A, FIG. 1B and FIG. 1C are illustrations of head-worn forward-illumination lamps of the prior art;

FIG. 2 is a top view of a solar-powered clip-on LED lamp 100 with a simplified internal-circuit diagram, shown forward mounted and set back on the brim 800-2 of a baseball cap 800, according to a first exemplary embodiment of the invention;

FIG. 3 is a side and partial cut-away view of a solar-powered clip-on LED lamp 200, shown forward mounted and set forward on the brim 900-2 of a hard hat 900, according to a second exemplary embodiment of the invention;

FIGS. 4A, 4B and 4C are top, front, and bottom views of a solar-powered clip-on LED lamp 300, configured to be forward mounted and set forward on the brim 800-2 of a baseball cap 800 (rim outline dotted), according to a third exemplary embodiment of the invention; and

FIG. 5 is a circuit diagram an exemplary solar-recharging LED lamp circuit for use in each of the lamps 100, 200 and 300 of FIGS. 2, 3, 4A, 4B, 4C.

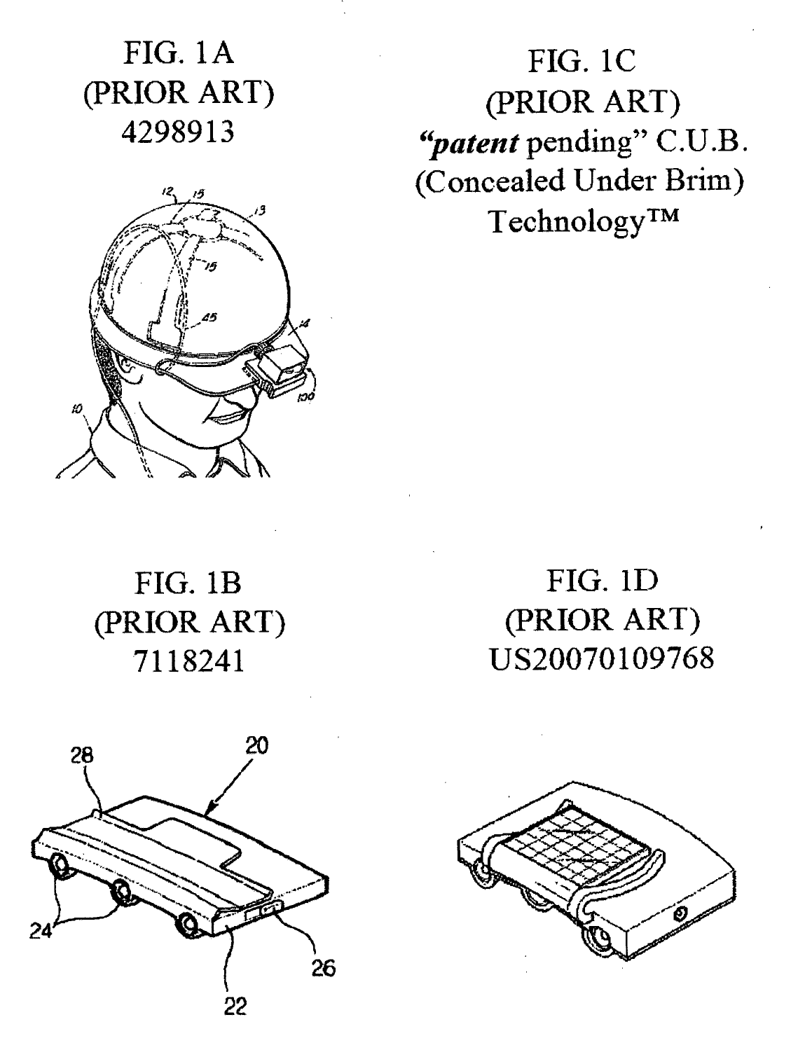

### DETAILED DESCRIPTION OF THE EXEMPLARY EMBODIMENTS

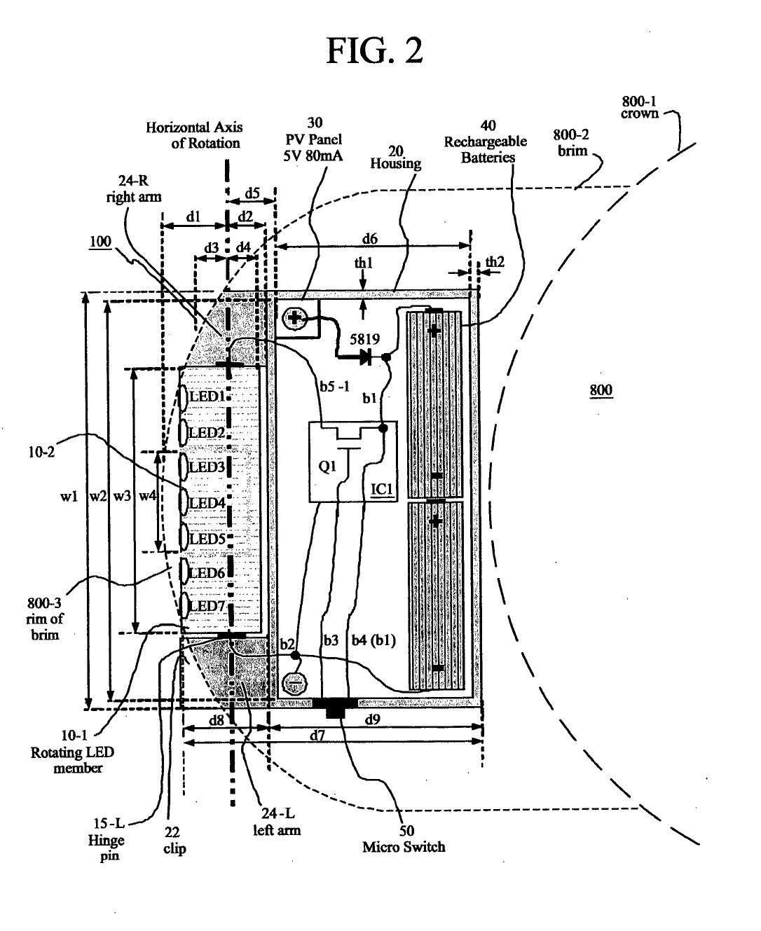

FIG. 2 is a top view of a solar-powered clip-on light emitting diode (LED) lamp 100 shown forward mounted (i.e., pointed forward while on the hat) and set back (back from the front of the rim) on the brim 800-2 of a baseball cap 800, according to a first exemplary embodiment of the invention. The lamp includes a housing 20 (case, body) and a rotating member 10. The housing 20 comprises a solar photo-voltaic (PV) panel 30 in its top surface and comprises an interior chamber for containing a rechargeable battery 40.

The housing also comprises two forward extensions 24 (“arms”: right arm 24-R and left arm 24-L) for supporting between them a rotating member 10 (e.g., 10-1) containing a plurality of light emitters (e.g., light emitting diodes) that rotates about a horizontal axis of rotation (HAoR) 2 that extends through the two forward extensions 24-R and 24-L.

The rotating member 10 (10-1) has a gross width w3 (measured parallel to the horizontal axis of rotation, and excluding any hinge pins 15 if attached to the rotating member 10) and a gross depth measured perpendicular to the HAoR. The rotating member 10 (10-1) may have a plurality of segments (10-1, 10-2 . . . ) that rotate about the horizontal axis of rotation independently or dependently of each other, to enable the wearer to direct light in one chosen angle Ø above or below the horizontal (i.e., a plane containing the HAoR and parallel to the plane including the lower edge of the crown of the hat) or in various angles Ø₁,Ø₂ at the same time according to his activity or need. Each segment (e.g., 10-1, 10-2, . . . ) of the rotating member 10 includes one or more light emitting diodes (LED). The gross width w3 of the rotating member 10 includes the widths of all of the plurality of the segments thereof. The gross width w3 of the rotating member 10 includes the widths (e.g., w4) of all of any plurality of the segments (e.g., 10-1, 10-2 . . . ) thereof, and is preferably less than the long dimension w2 of the solar panel, and may be greater than the short dimension d6 of the solar panel. The back (opposite the LEDs) end of the rotating member 10 may extend back a significant distance d4 from the HAoR/hinge 15 if such needed to provide structural strength or to provide space for LED leeds or interconnections and/or for a printed circuit board inside the rotating member 10.

The angle Ø above or below the horizon at which the illumination is projected (e.g., forward and/or downward) may be adjusted by the user without changing the position of the hat on the user's head.

The plurality of LEDs in the rotating member 10 in the exemplary embodiment preferably comprises one or more or all high intensity light emitting diodes (LED) that radiate light in a broad spectrum so as to appear white to the human eye. One example of a white LED is Model No. NSPW500BS manufactured by Nichia Corporation of Japan. In general LEDs selected for incorporation into various embodiments of the invention may vary in size, color output, and manufacturer. Various embodiments may be modified so as to incorporate any and all LEDs of whatever size, shape and color output, which can be incorporated into the lamp within the broadest parameters of its design and purpose. Each LED typically has its own lens that provides and defines an optical axis of the light emitted therefrom.

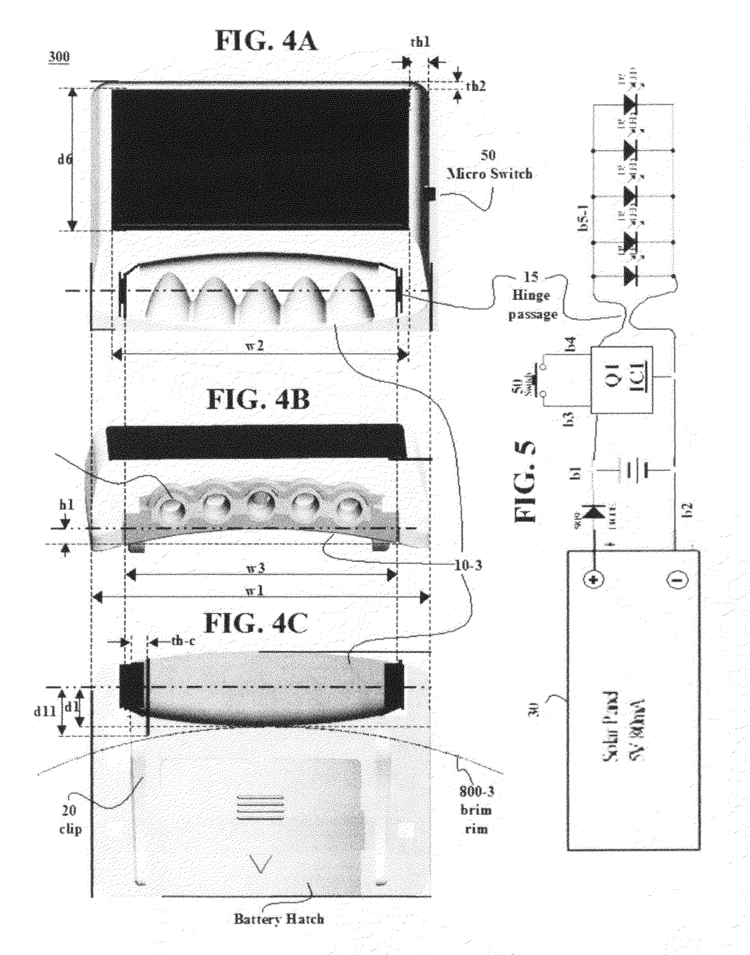

A plurality of the light emitting diodes fixed in the rotating member 10 can be aligned to have their optical axes in the same plane and parallel to other so as to project a beam of light at a user-selected angle Ø, above or below horizontal. A plurality of the light emitting diodes fixed in the rotating member 10 can be aligned to have their optical axes parallel to each other, but not in the same plane, (e.g., in an arch configuration as shown in FIG. 4B) to project a brighter combined beam of light at a user-selected angle Ø, above or below horizontal. A plurality of the light emitting diodes fixed in the rotating member 10 can be aligned to have their optical axes in the same plane but not parallel to each other (e.g., fanned out as shown in FIG. 4A) to project a wide beam of light at a user-selected angle Ø, above or below horizontal. A plurality of the light emitting diodes fixed in the rotating member 10 can be aligned to have their optical axes not in the same plane and not parallel to each other (e.g., arched and fanned out as shown in exemplary embodiment 300 of FIGS. 4A and 4B).

At least one light emitting diode of the plurality of light emitting diodes may emit light of a color other than white light, such as red light, blue light, green light, yellow light, infrared light or ultraviolet light. Ultraviolet LEDs may be inserted to allow the user to see substances that fluoresce under ultraviolet light, such as but not limited to certain minerals, fluorescent inks or paint, spotting of carpets due to spraying or urination of pets, and certain creatures (e.g., scorpions) with UV fluorescent pigments or body parts. Infrared LEDs may be used to provide a light source for infrared-activated night spotting scopes. The rotation angle Ø of one or more or all segments (10-1, 10-2) of the rotating member 10 may be limited (e.g., by bumpers, protrusions, or stops, or by collision with the rim of the brim) so as to prevent stray or directed light of a predetermined color from entering the user's eyes. For example, a segment 10-1 of the rotating member 10 bearing an LED emitting ultraviolet light (which may be useful for those engaged in spelunking, geology, forensics, or scorpion hunting) may have its downward range of rotation inhibited or limited so as to prevent eye-injury to the user.

The housing has a gross width w1 which is slightly wider than the long dimension w2 of the solar PV panel 30. The housing has a gross depth d7 (equal to depth d8 of extensions 24 plus main body depth d9) which is greater than the narrow dimension d6 of the solar PV panel 30. The gross depth d7 includes the depth of each of the two forward extensions 24 (“arms”: right arm 24-R and left arm 24-L), plus the depth d9 of the main case portion that includes the solar PV panel 30.

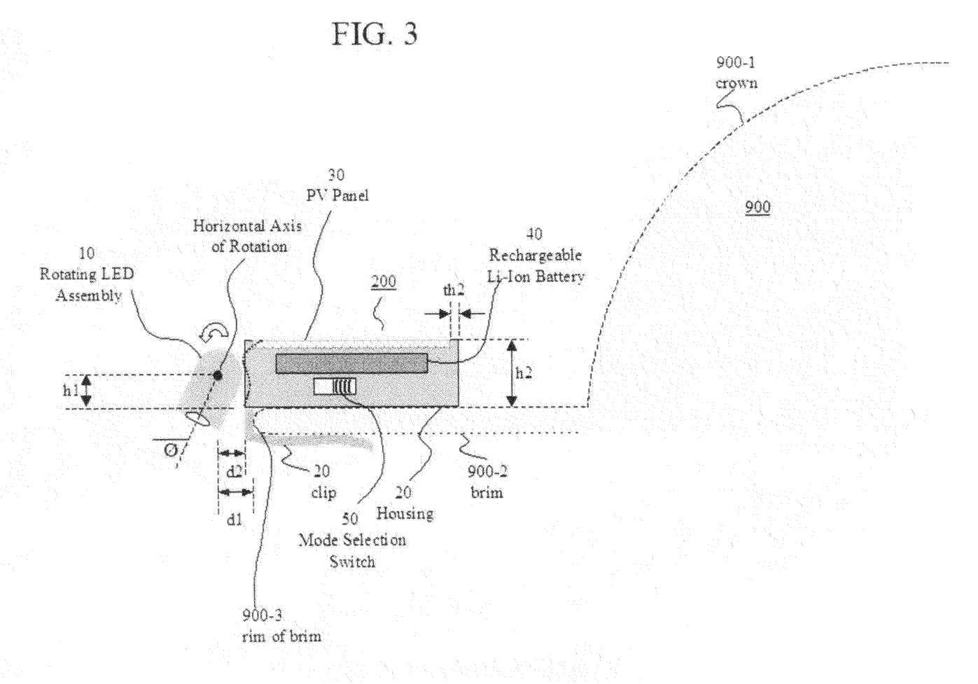

The outer edges of the solar PV panel 30 which comprises brittle silicon PV wafers, are protected from impact during storage or handling by minimized thicknesses th1, th2, (and th3 see FIG. 3) of the material of the housing around its perimeter, which may comprise a durable plastic. The minimal thicknesses th1, th2, (and th3 see FIG. 3) may be about 2 mm or less. The upper surface of the silicon PV wafer in the solar PV panel 30 may be protected by a conformal layer of transparent material such as resin or an epoxy. The solar PV panel 30 preferably has a rectangular perimeter shape (as shown from above in FIGS. 2 and FIG. 4A), and thus has two lines of symmetry, a long axis (having length w2) parallel to the axis of rotation, and a shorter axis (having length d6) perpendicular to the long axis. The long axis and the shorter axis of the solar PV panel 30 intersect at the geometric centroid of the solar PV panel 30 and are together in the same plane, but are not necessarily in the same plane as contains the horizontal axis of rotation (HAoR) 2. Preferably, the horizontal axis of rotation (HAoR) 2 will be below the centroid of the solar PV panel 30. The horizontal axis of rotation (HAoR) 2 is a distance d5 forward of the forward edge of the solar PV panel 30 and a distance d2 forward of the front side of the main body of the housing 20. In alternative embodiments, the solar panel 30 and the top and bottom faces of the housing 20 will be formed have a curved or arched (convex) shape approximately conformal to the curve or arch of a baseball cap's brim. The geometric centroid of a convex object always lies within the perimeters of the object. The central point on the surface of a convex solar PV panel 30 will be above the geometric centroid. Thus, in such convex solar PV panel 30 embodiments, the horizontal axis of rotation (HAoR) 2 may be at the same height as, below, or above the centroid of the curved/arched (convex) solar PV panel 30, or above a lower edge or lower portion of the solar PV panel 30. In such alternative embodiments, one or more or all of the LEDs in the rotating member 10 may have its optical axis (while positioned horizontally) fixed above the horizontal axis of rotation (HAoR) 2 (as shown in the exemplary embodiment of FIG. 4B). In such alternative embodiments, and in variations of the exemplary embodiment 100 of FIG. 2, and as shown in the exemplary embodiment 200 of FIG. 3, one or more or all of the LEDs in the rotating member 10 may have its optical axis (while positioned horizontally) positioned below the central point in the top surface of the solar PV panel 30.

In each alternative embodiment in which one or more or all of the LEDs in the rotating member 10 has its optical axis (while positioned horizontally) fixed above the horizontal axis of rotation (HAoR) 2 (e.g., as shown in the exemplary embodiment of FIG. 4B.), depending on the position (distance d1) of the clips 22 relative to the (HAoR) 2, the LEDs can be rotated to shine light forward downward, or “straight down”, and even back to illuminate the face of the wearer. In such alternative embodiments, in which one or more or all of the LEDs in the rotating member 10 may have its optical axis (while positioned horizontally) fixed above the horizontal axis of rotation (HAoR) 2 (as shown in the exemplary embodiment of FIG. 4B.), when the user rotates the rotating member 10 at a downwards angle from the horizontal orientation, the LEDs themselves will be rotated forward and their optical axis may be positioned vertically beyond (forward of) the rim of the brim sufficiently to shine light downward and even “straight down” onto the ground. This is achieved even though, while the LEDs in the rotating member 10 remained in the horizontal orientation they directed no stray light vertically to the ground because the rim of the brim obstructed stray light in that direction. Thus, when only forward illumination is desired, the user's eyes can be completely protected from stray light emitted from the LED (in a direction other than along the main optical axis) by the brim, but when the user desires light to be directed downwards, the optical axis of one or more or all of the LEDs can be readily directed downwards, even straight down, and even back towards the user's face. Thus, a problem of stray light escaping from LEDs fixed in the rim or in the underside of the brim of a baseball cap and entering the user's eyes when only forward illumination is desired is overcome in various exemplary embodiments of the invention. Such stray light can be a problem because it may enter the human eye at a relatively high brightness (compared to the ambient darkness, and compared to the forward object intended to be illuminated) and thus may cause the human iris to contract, reducing the total visibility of forward objects that are intended to be illuminated.

When only forward-illumination and downward-forward illumination is desired as a matter of utility, the position (distance d1) of the rim (and distance d3 of the clips 22) relative to the HAoR 2, the LEDs may be selected so that only forward-illumination and downward-forward, or upward, illumination is obtained without any stray light entering the user's eyes. When a more complete angular range of illumination is desired to be available as a matter of utility, the position (distance d1) of the rim (and distance d3 of the clips 22) relative to the horizontal axis of rotation (HAoR) 2, may be selected so that the HAoR is nearer to, at, or forward of the rim of the brim 800-2 of the baseball cap, sufficiently that forward, straight-down and even facial illumination may be obtained by the user. In various embodiments, such as LAMP 100 in FIG. 2, the user can select the position (distance d1) of the horizontal axis of rotation (HAoR) 2 relative to the rim of the brim 800-2 of the hat by pulling the lamp 100 forward or pushing it backwards while the clip or clips 22 still hold it securely onto the brim 800-2.

In various alternative embodiments, the forward-backward position (distance d3) of the clips 22 relative to the horizontal axis of rotation (HAoR) 2 can be adjustable so as to be adjusted by the user to suit his immediate needs. The clips 22 extend below the brim 800-2 and below the housing 20, and elastically deform and apply a force on the bottom side of the brim 800-2 and on the bottom side of the housing 20. The applied force from the elastic clips 22 generates a static friction force that detachably holds the lamp 100 in place on the brim 800-2.

Below the solar PV panel 30, within the housing 20, is a chamber for containing a rechargeable battery or batteries 40 (e.g., having a nominal voltage of approximately 3 volts or at least 1.2 volts), an anti-discharging diode 5819, a lamp-driving IC (101) and interconnection wires b1, b2, b3, b4, b5-1. The battery 40 is the only component that may need to be removed for purposes of upgrading, charging or replacement. Such removal or replacement can be facilitated by providing a conventional hinged door, slide-off cover, or the like (not shown) in the bottom of the housing 40 (e.g., slide-off battery hatch 52 as shown in FIG. 4C).

Negative power supply wire b2 extends from the negative terminal of the rechargeable battery (or batteries) 40 through one arm (e.g., 24-L or 24-R) and through a passage in the corresponding hinge pins(s) 15 to the LEDs (LED1, LED2, LED3, LED4, LED5, LED6, LED7) in the rotating member 10 (e.g., 10-1). Negative power supply wire b2 also branches to the controller IC1 and to the negative terminal of the solar PV panel 30. Positive power supply wire b1 extends from the positive terminal of the rechargeable battery (or batteries) 40 into the controller IC1, and (through or around 101) to one terminal of the mode-selection switch 50 (e.g., a microswitch) through wire b4. Wire b3 connects the second terminal of the mode-selection switch 50 directly (as shown) or indirectly to the control gate of a switch (e.g., a field effect transistor, FET Q1) inside the controller IC1 to energize the LEDs in the rotating member 10 (e.g., 10-1) in the mode of operation desired (e.g., bright, dim, flashing, etc.). One terminal of switch Q1 is connected directly (as shown) or indirectly to the positive power supply wire b1, and the other terminal of switch Q1 is connected to a wire b5-1 which extends through one arm (e.g., 24-L or 24-R) and through a passage in the corresponding hinge pins(s) 15 to the LEDs (LED1, LED2, LED3, LED4, LED5, LED6, LED7) in the rotating member 10 (e.g., 10-1). In various alternative embodiments, additional switches (e.g., Q2, Q3, Q4, not shown) may be included in the controller IC1 together with additional wires (e.g., b5-2, b5-3, etc. not shown), and additional control circuitry for independent control over the mode of operation of each individual LED or of each grouping of LEDs, as is well known to persons skilled in the art.

In exemplary embodiments a passage hole (conduit) through the center of each plastic hinge pin 15 at each end of the rotating member 10 (e.g., 10-1) provides a passage that can accommodate at least 4 flexible insulated wires of an appropriate gage to conduct driving current to high brightness LEDs in the rotating member 10. In various alternative embodiments, the number of wires through the plastic hinge pin 15 (e.g., 15-L or 15-R) at each end of the rotating member 10 can be reduced or minimized to just three wires by relocating the controller IC1 inside of the rotating member 10 so that only three wires (b1, b2 and b3) need be passed through the hinge pins 15 into the rotating member 10. The minimization of the number of wires is facilitated where the mode control switch 50 is a momentary-contact type switch and the mode of operation of the lamp depends upon the number of times (as detected by the controller IC1) that the user has pressed the mode-control switch 50, as is well know by persons skilled in the art. Other systems of encoding mode-control commands over a single wire (b3) are known and available for use in alternative embodiments. If electronic control of the voltage and/or current conducted to the LEDs in the rotating member 10 is desired for purposes of strobing, pulsing (e.g., with pulse width modulation for the purpose of increasing or decreasing its apparent brightness and conserving power), flashing, or varying the intensity of the LEDs, the integrated circuit 101 may comprise the digital or analog components to accomplish the desired electronic control of switch Q1.

It is preferred that the wires (e.g., b2 and b5-1 or b1, b2 and b3) extending between housing 20 and the rotating member 10 are concealed and protected by their interior passage through the hinge pins 15 (e.g., 15-R or 15-L), but in alternative embodiments, these wires can be external to the hinges in which case one or both hinge pins can be made solid instead of hollow. The hinge pins 15 (e.g., 15-R or 15-L) can be fixedly attached to either the extension (arms 24-L and 24-R) of the housing 20 or to the rotating member 10 (e.g., 10-1), or to neither. In preferred embodiment, the hinge pins 15 (e.g., 15-R and 15-L) are fixedly attached the rotating member 10, and a static friction force is developed between the each of the hinge pins 15 (e.g., 15-R and 15-L) and the extension (arms 24-L and 24-R) of the housing 20. The hinge pins 15 may be formed entirely of a hard plastic, or other hard material or coated with a rubbery coating that provides a greater coefficient of friction. The static friction force sufficient to arrest unintended movement of the rotating member 10 can be generated by separately forming the housing 20 and/or each extension (arms 24-L and 24-R) as an upper shell and a lower shell and combining them with the hinge pin (fixedly attached to the rotating member 10) disposed at the seem or within a conformal (barrel-shaped) recess therebetween. Additionally, a small screw can be disposed in each extension (arms 24-L and 24-R) for to generates the static friction force sufficient to arrest unintended movement of the rotating member 10. The rotating member 10 itself may comprise an upper shell and a lower shell that are joined together with each of the plurality of LEDs disposed therebetween. Additionally, the upper shell of the rotating member 10 may comprise an upper half of each hinge pin 15, while the lower shell of the rotating member 10 may comprise a lower half of each hinge pin 15. Upper and lower shells meet to form a seem therebetween.

The entire seem between the upper shell and the lower shell of the housing 20 need not be disposed within a given plane. A portion of the seem between the upper shell and lower shell of each extension (arms 24-L and 24-R) of the housing 20 preferably are comprised in the horizontal plane including the horizontal axis of rotation (HAoR) 2, to facilitate positioning of the hinge pins 15 (e.g., fixedly attached to the rotating member 10 therebetween). Similarly, a plane bisecting each of the hinge pins 15 (fixedly attached to the rotating member 10) at the seem separating the upper and lower halves thereof will preferably contain the horizontal axis of rotation (HAoR) 2, to facilitate the positioning of wires axially through hollow hinge pins 15, but other variations in the manner of construction and assembly are practicable.

FIG. 3 is a side and partial cut-away view of a solar-powered clip-on LED lamp 200, shown forward mounted and set forward on the brim 900-2 of a hard hat 900, according to a second exemplary embodiment of the invention.

In FIG. 3, a lamp 200, according to a second exemplary embodiment of the invention, having a transparent plastic housing 20 is seen from the side, with the two forward extensions 24 (“arms”: right arm 24-R and left arm 24-L not shown) cut away to clearly show the position of the rotating member 10 containing a plurality of light emitters (e.g., light emitting diodes LED1, LED2, etc.) that rotates about a horizontal axis of rotation (HAoR) 2 that extends through the two forward extensions 24-R and 24-L (not shown in FIG. 3). In lamp 200, the optical axis of at least one of the LEDs in the rotating member 10 intersects the horizontal axis of rotation (HAoR) 2. In various alternative embodiments, the optical axis of at least one of the LEDs in the rotating member 10 intersects perpendicularly the horizontal axis of rotation (HAoR) 2. In alternative embodiments, the optical axis of one or more or all of the LEDs in the rotating member 10 may be above (not intersecting) the horizontal axis of rotation (HAoR) 2 (e.g., as shown in FIG. 4B). In various alternative embodiments, the optical axis of one or more or all of the LEDs in the rotating member 10 intersects the horizontal axis of rotation (HAoR) 2, but not perpendicularly (e.g., “fanned out” to the sides as shown in FIG. 4A).

The clip or clips 22 are positioned back on the main body of the housing 20 (i.e., not attached forward on the extensions 24) so that the horizontal axis of rotation (HAoR) 2 is positioned a distance d1 forward of the rim 900-3 of the brim 900-2 of a hard hat 900 and a distance d3 forward of the clip 22. In other words, the position of the clips 22 shown in FIG. 3 ensures that the lamp 100 will be forward mounted (i.e., pointed forward while on the hat) and set forward (i.e., the HAoR is forward of the rim 900-3) on the brim 900-2 of a hard hat 900. This positioning of the clip 22 and rim 900-2 relative to the HAoR 2 ensures that the user can position the rotating member 10 so that the light emitted is directed at a desired angle Ø relative to the horizontal (e.g., a plane containing the HAoR 2 and parallel to the plane including the lower edge of the crown of the hat) according to his activity or need, including angles Ø that are upward, forward, downward, straight down, and even back to illuminate the face of the user.

The downward angle Ø of the optical axis of an LED on the rotating member 10 can be maximized by positioning the LED within the rotating member 10 so that its optical axis is above the HAoR 2 (as shown in FIG. 4B), which provides during downward rotation a greater clearance between the LED and the rim 900-3 and can result in the LED or at least a light emitting end of the lens thereof being positioned below the rim 900-3 (e.g., while it projects light onto the user's face). Preferably, the optical axis of one or more or all of the LEDs in the lamp 200, while the axis is in a horizontal plane, is positioned above the HAoR 2 and below the top plane of the housing (i.e., below gross housing height h2). Preferably, the top most exterior surface of the rotating member 10 (e.g., while the degree of rotation Ø is zero), is not significantly higher than the top plane of the housing 20 (i.e., not higher than gross housing height h2) to prevent its shadow from interfering with incoming solar radiation impinging on the energy-collecting surface of the solar PV panel 30 provided on the top plane of the housing 20.

The upward angle Ø of the optical axis of an LED on the rotating member 10 can be limited by positioning the LED within the rotating member 10 so that the optical axis of the LED above the HAoR 2 (as shown in FIG. 4B), and/or shaping the rotating member and the housing 20 to provide a collision therebetween limiting the upward rotation of the rotating member 10. This further prevents the rotating member 10 from casting a shadow that would interfere with incoming solar radiation impinging on the energy-collecting surface of the solar PV panel 30 provided on the top plane of the housing 20.

In various alternative embodiments, the rotating member 10 can be miniaturized in its dimensions perpendicular to the HAoR 2 and/or positioned farther forward (d1 longer forward) from the housing 20 to prevent the rotating member 10 from casting a shadow that would interfere with incoming solar radiation impinging on the energy-collecting surface of the solar PV panel 30 provided on the top plane of the housing 20. In such alternative embodiments, the rotating member 10 may have at least a 360 degree range of rotation about the HAoR 2, and the electrical connections between the housing 20 and the rotating member 10 (e.g., through wires b2, b3 and b5-1) may be effected by providing conventional ring-and-brush electrical contacts about one or both of the hinge pins 15.

A rechargeable battery 40 is disposed in the interior chamber in the main body of the housing 20 below the solar PV panel 30. The rechargeable battery 40 may be of any type currently known, or of any type to become known in the future, such as NiCD (Nickel—Cadmium) and NiMH (Nickel-Metal Hydride), or Li-Ion (Lithium Ion), and may have a round (e.g., AAAA, AAA, AA), squared, or flat pack shape

The gross height h2 of the housing 20 is preferably minimized according to the shape and size of the selected rechargeable battery 40 to be contained in the interior chamber of the housing 20. A flat-pack Li-Ion battery is preferably selected and used as the rechargeable battery 40, and thus the gross height h2 of the housing 20 (measured between the top surface of the brim 900-2 and the top plane (e.g., solar PV Panel 30) of the housing 20) may be minimized to be minimally greater than the thickness of the flat-pack Li-Ion battery to be contained in the interior chamber of the housing 20. The gross height h2 of the housing 20 is preferably less than one inch, and is optimally less than 0.5 inches (above the highest top surface of the brim). When a flat-pack Li-Ion battery having a thickness of 5 mm is selected as the rechargeable battery 40, the gross height h2 of the housing 20 may be easily manufactured to be about 10 mm, or between 8 mm and 15 mm. The topmost part of the rotating member while an optical axis of an LED therein is in horizontal direction, may be lower than, or higher than the top plane (e.g., solar PV Panel 30) of the housing 20, but the HAoR 2 is preferably not higher than the top plane (e.g., solar PV Panel 30) of the housing 20 (as shown in FIG. 4B). And, the optical axis of the highest (not shown in FIG. 3) LED (while in a horizontal direction) in the rotating member 10 is preferably higher than height h1 of the HAoR 2 but not higher than the height h2 of the top plane (e.g., solar PV Panel 30) of the housing 20 (as shown in FIG. 4B). Similarly, the optical axis of the lowest (e.g., as shown in FIG. 3) LED (while in a horizontal direction) in the rotating member 10 is preferably not lower than height h1 of the HAoR 2 but may be higher than height h1 of the HAoR 2 (as shown in FIG. 4B).

Preferably, the optical axis of one or more or all of the LEDs in rotating member 10 of the lamp 200, measured while its optical axis is horizontal, is above height h1 of the HAoR 2 and below the height h2 of the top (plane) of the housing 20, but embodiments of the invention are not limited to that preference. Thus, in various alternative embodiments, the optical axis of one or more or all of the LEDs in rotating member 10 of the lamp 200 may be above height h2 of the top plane of the housing 20, while the height h1 of the HAoR 2 is below the height h2 of the top of the housing 20. In such embodiments, the rotating member 10 preferably has a thin dimension such that the rotating member 10 can be rotated into a position so as not to cast a shadow on the solar panel while the sun is at an angle greater than 10 degrees above the local horizon, and preferably the rotating member 10 does not extend below the brim 800-2 while in that position.

Embodiments of the invention may be manufactured and/or sold without containing a rechargeable battery 40, but preferably have an interior chamber in the housing 20 for containing and connecting a rechargeable battery 40. The rechargeable battery 40 can be installed, replaced or upgraded by retailers and/or by users as available rechargeable battery technology (e.g., energy density, charging efficiency, shelf life) improves. If battery and or solar-panel technology improves to the extent that the combined thickness of the battery 40 and solar PV panel 30 having suitable energy-collection and energy-storage capacity is less than three millimeters, then the gross height h2 of the main housing 20 may be accordingly reduced to about five millimeters or less. In that case, in various alternative embodiments of the invention, the height h1 of the horizontal axis of rotation (HAoR) 2 may be less than, equal to or greater than the height h2 of the main body of the housing, and the height of each of the extensions (left arm 24-L and right arm 240R shown in FIG. 2) may be higher than height h2 of the main body of the housing In that case, the height h1 of the horizontal axis of rotation (HAoR) 2 is preferably less than 0.25 inches, and the optical axis of the highest LED in the rotating member 10 is preferably higher than height h1 of the HAoR 2 but not higher than 0.5 inches. In that case, the optical axis of the highest LED in the rotating member 10 is preferably about 0.25 inches above the height h1 of the HAoR 2.

FIGS. 4A, 4B and 4C are top, front, and bottom views respectively, of a solar-powered clip-on LED lamp 300, configured to be forward mounted and set forward (i.e., the HAoR is forward of the rim 800-3) on the traditionally curved brim 800-2 of a baseball cap 800 (rim 800-3 outline dotted), according to a third exemplary embodiment of the invention. Referring to the current embodiment illustrated in FIGS. 4A, 4B, and 4C, the lamp 300 includes a housing 20 (case, body) and a rotating member 10 (10-3), both of which have non-flat (e.g., curved) bottom surfaces corresponding to the traditional curve of a baseball cap brim 800-3. This first curve in the rotating member 10 (10-3) is maintained in its top and bottom surfaces and in the seem between its top shell and its bottom shell. Each of the LEDs (e.g., LED1, LED2, LED3, LED 4, and LED 5) is set at a different point along the curved seem between the top shell and the bottom shell of the rotating member 10 (10-3), and thus this first curve raises each of the plurality of LEDs (e.g., LED1, LED2, LED3, LED 4, and LED 5) therein into a curved (non-linear) configuration above the horizontal axis of rotation (HAoR) 2 (see FIG. 4B). This curved elevation of the LEDs above the HAoR 2 provides the features hereinabove attributed to having the optical axes of one or more or all of the LEDs in the rotating member 10 positioned above the HAoR 2. Additionally, the first curve in the rotating member 10 (10-3) optimally positions each of the LEDs forward of the rim 800-3 when the rotating member 10 is rotated downward such that the optical axis of the center LED is “straight down” or when the LEDs are pointed “back under” the brim 800-2 to illuminate the face of the user.

As shown in FIGS. 4A, 4B and 4C, in an exemplary embodiment, the top side of the main body of the housing 20 may be flat corresponding to a flat solar PV panel, while the bottom side of the main body of the housing 20 has a convex curved (arcuate) shape conforming to the traditional curve of a baseball cap. Meanwhile, the bottom side of the rotating member 10 has a concave curved (arcuate) shape corresponding to the curve of the forward edge of the rim 800-3 of a baseball cap 800. The HAoR intersects the middle of the bottom side of the rotating member 10 having a concave curved (arcuate) shape, or intersects a point within 1 millimeter of the bottom surface of the rotating member 100. The top side of the rotating member 10 may also have an arcuate (convex) shape corresponding to the curve of the bottom side of the rotating member 10. A plurality of LEDs are disposed on the front surface of the rotating member along an arc extending between the lateral ends (hinges) of the front surface and between the arcuate top side and arcuate bottom side of the rotating member 10.

As shown in FIG. 4A, the forward surface of the rotating member 10 (10-3) has a second curve, and each of the LEDs (LED1 through LED5) has its optical axis set approximately perpendicular to its point along that curved forward surface. Thus the LEDs (LED1 through LED5) are “fanned out” but with overlapping beams to distribute light in a combined beam wider and/or brighter than the beam along the optical axis of a single one of the LEDs, when all of them are emitting light. A reflective (e.g., mirrored, “chromed”) barrel and/or parabolic reflector 13 may be disposed around and forward of the lens of each of the LEDs to limit the escape of stray light perpendicular to the optical axis of each LED, and to further concentrate emitted light into a beam centered on the optical axis of each LED.

To simplify manufacture and assembly of the lamp 300, each of the circular (e.g., parabolic) reflectors 13 can be ganged into a single reflector module by providing structurally interconnecting material therebetween. The plurality of parabolic reflectors 13 and the interconnecting material therebetween may be simultaneous formed and then “chromed” as one piece (module) and then handled as a single piece during assembly. Similarly, each of the plurality of LEDS (LED1 through LED5) can be mounted as a gang on an elongate printed circuit board to be disposed within the rotating member 10 (10-3). The gang of LEDs mounted on the printed circuit board may then be easily mated with to the gang of parabolic reflectors and thus united disposed in the chamber and the seem between the upper and lower shells of the rotating member 10 (10-3). The seem between the upper shell and lower shell of the rotating member may be waterproof.

In the current embodiment, the controller IC1 can be mounted on the printed same circuit board as the LEDs inside of the rotating member (if it is miniature enough to fit inside the rotating member), or the controller IC1 can be disposed within the main body of the housing 20 (as shown in FIG. 2). If the controller IC1 is located inside of the rotating member 10 (10-3) the number of wires through the plastic hinge pin 15 (e.g., 15-L or 15-R) at one end of the rotating member 10 can be reduced or minimized to just three wires (b1, b2 and b3) that need be passed through the hinge pin 15 into the rotating member 10 (10-3). If all of the LEDs (LED1 through LED5) in the rotating member 10 (10-3) are to be driven the same, (e.g., all in parallel or all in series) then only two wires (b2 and b5-1) need be passed through the hinge pin 15 into the rotating member 10 (10-3), as shown in FIG. 2 and in FIG. 5.

In the current embodiment, as illustrated in FIG. 4B, the upper and lower shells of the rotating member 10 (10-3) do not have reflective symmetry along the seem between them, except at each (left and right) hinge pin 15. However, as shown in FIGS. 4A, 4B and 4C, the rotating member 10 (10-3) does have reflective symmetry along a middle plane perpendicular to the HAoR 2. As illustrated in FIG. 4B, the left and right sides of the main body of the housing 20 and of the extensions (left arm 24-L and right arm 24-R) thereof comprise planes perpendicular to the HAoR 2 above and below the seem between the upper and lower shells thereof and also a sloped or inverted parabolic bevel above the seem, which simplifies manufacture and provides a greater contact area between the bottom surface of the housing 20 and the top surface of the brim 800-2 of the baseball cap 800. In various alternative embodiments, the left and right sides of the main body of the housing 20 and of the extensions (left arm 24-L and right arm 24-R) may be substantially planar above and below the seem, comprising planes perpendicular to the HAoR 2 (as shown in FIG. 2).

In the current exemplary embodiment, the gross width w1 of the housing is about 85 millimeters, and the gross depth d7 of the housing (including extensions) is about 60 millimeters, and the gross height h2 of the housing is about 19.5 millimeters.

The current embodiment provides a complete angular range of illumination because the position (distance d1) of the rim (and distance d3 of the clips 22) relative to the horizontal axis of rotation (HAoR) 2, has been selected so that the HAoR is forward of the rim 800-3 of the brim 800-2 of the baseball cap 800, sufficiently that forward, straight-down and even “back under” facial illumination may be obtained by the user. The clips 22 extend below the brim 800-2 and below the main body of housing 20, and elastically deform and apply a force on the bottom side of the brim 800-2 and on the bottom side of the housing 20. The applied force from the elastic clips 22 generates a static friction force that detachably holds the lamp 300 in place on the brim 800-2. In the current embodiment, the fixed end each of the clips 22 is integrated with the main body of housing 20 (not integrated with the extensions, arms 24-L and 24-R). In various alternative embodiments, other known or future known attachment apparatus may be employed to removably secure the bottom of the housing 20 to the top of the brim 800-2 of the baseball cap 800, such as, for example, Velcro® attachments, pins, hooks, snaps, buttons, screws, nut-and-bolt, threads, YKK® zippers, Ziploc® zippers, and the like.

Various alternative embodiments of the invention may comprise two metal clips as taught in U.S. Pat. 7,506,992 incorporated by reference herein. In such alternative embodiments of the invention, at least two steel spring clips are attached to the housing 20 or to extensions 24 thereof and extend below the bottom surface of the housing 20. The metal spring clip provides a static frictional force that holds the lamp in position on the brim 800-2 of the cap when the brim 800-2 is interposed between the spring clip and the bottom surface of the housing 20.

The upper shell and lower shell the housing 20 may be permanently fused together with a glue or epoxy, or thermoplastic weld, or semipermanently joined to each other by screws, clamps, nails, magnets, threads, staples, snaps, snap-fittings, or integral plastic latches, or other joining systems known in the related art. The seem between the upper shell and lower shell of the housing 20 may be waterproof. A battery hatch 52 (shown in FIG. 4C) is disposed on the bottom side of the main body of the housing 20 to facilitate installation, removal, replacement or upgrading of the rechargeable battery 40 (not shown in FIGS. 4A, 4B, 4C) to be contained in the chamber within main body of the housing 20.

FIG. 5 is a circuit diagram an exemplary solar-recharging LED lamp circuit for use inside each of the lamps 100, 200 and 300 of FIGS. 2, 3, 4A, 4B, 4C.

Below the solar PV panel 30, within the housing 20 in each of the exemplary lamps 100, 200 and 300 of FIGS. 2, 3, 4A, 4B, 4C, is a chamber for containing a rechargeable battery or batteries 40 (e.g., having a nominal voltage of approximately 3 volts or at least 1.2 volts), an anti-discharging diode 5819. The chamber may additionally contain the lamp-driving IC (controller IC1) and interconnection wires b1, b2, b3, b4, b5-1. The battery 40 is the only component that may need to be removed for purposes of upgrading, charging or replacement, and thus may be omitted from any of the exemplary lamps 100, 200 and 300 of FIGS. 2, 3, 4A, 4B, 4C at the time of manufacture or sale.

While exposed to light (e.g., sunlight), the solar PV panel 30 charges/recharges the rechargeable battery 40 through the forward biased diode 5819 and through positive power supply wire b1 and negative power supply wire b2. When the solar PV panel 30 is not exposed to light (e.g., sunlight), it has a lower voltage than the charged voltage of the rechargeable battery 40 and is thus “reverse biased” and is “OFF” (i.e., nonconducting).

Negative power supply wire b2 extends from the negative terminal of the rechargeable battery (or batteries) 40 through one arm (e.g., 24-L or 24-R) and through a passage or hole through the corresponding hinge pins 15 to the plurality of LEDs (e.g., LED1, LED2, LED3, LED4, LED5) in the rotating member 10 (e.g., 10-1). Negative power supply wire b2 also branches to the controller IC1. Positive power supply wire b1 extends from the positive terminal of the rechargeable battery (or batteries) 40 into the controller IC1, and (through or around 101) to one terminal of the mode-selection switch 50 (e.g., a microswitch) through wire b4. Wire b3 connects the second terminal of the mode-selection switch 50 directly (as shown) or indirectly to the control gate of a switch (e.g., a field effect transistor, FET Q1) inside the controller IC1 to energize the LEDs in the rotating member 10 (e.g., 10-1) in the mode of operation desired (e.g., bright, dim, flashing, etc.). One terminal of switch Q1 is connected directly (as shown in FIG. 2) or indirectly to the positive power supply wire b1, and the other terminal of switch Q1 is connected to a wire b5-1 which extends through one arm (e.g., 24-L or 24-R) and through a passage/hole in the corresponding hinge pin 15 to the LEDs (LED1, LED2, LED3, LED4, LED5, LED6, LED7) in the rotating member 10 (e.g., 10-1). In various alternative embodiments providing for independent control over the mode of operation of each individual LED or of each grouping of LEDs in the rotating member 10, additional switches (e.g., Q2, Q3, Q4, not shown) together with additional control circuitry may be included in the controller IC1 for independent control and operate with additional wires (e.g., b5-2, b5-3, etc. not shown) operatively connected to the LEDs.

The foregoing is illustrative of exemplary embodiments of the invention and is not to be construed as limiting thereof. Although a few exemplary embodiments of the invention have been described, those skilled in the art will readily appreciate that many modifications are possible in exemplary embodiments of the invention without materially departing from the novel teachings and claims. Accordingly, all such modifications are intended to be included within the scope of this invention as defined in the claims. Therefore, it is to be understood that the foregoing is illustrative of various exemplary embodiments of the invention and is not to be construed as limited to the specific embodiments disclosed, and that modifications to the disclosed embodiments, as well as other embodiments, are intended to be included within the scope of the appended claims.

I claim:

1. A lamp for engagement with a brim of a hat, comprising:
a housing including a main body having a front side, and a top side including a planar photovoltaic (PV) panel, wherein the PV panel is configured for charging a rechargeable battery;
a first hinge on the front side of the housing and having a horizontal axis of rotation (HAoR), wherein the HAoR is in a horizontal plane below the plane of the solar panel;
a first rotatable member, holding a first light emitter having a first optical axis, that rotates about the HAoR;
a chamber in the main body of the housing and below the photovoltaic (PV) panel for containing the rechargeable battery;
a first switch for controlling the first light emitter and configured to be connected in series between the rechargeable battery and the first light emitter; and
a fastener for removably attaching the lamp to the brim of the hat.

2. The lamp of claim 1, wherein the first light emitter is a light emitting diode (LED) and includes a lens.

3. The lamp of claim 1, wherein the first light emitter further includes a reflector centered around the first optical axis.

4. The lamp of claim 1, wherein the optical axis of the first light emitter does not intersect the HAoR.

5. The lamp of claim 4, wherein the while the first optical axis is horizontal the first optical axis is in a horizontal plane higher than the horizontal plane containing the HAoR.

6. The lamp of claim 5, wherein while the first optical axis is horizontal the first optical axis is approximately 0.25 inches higher than the horizontal plane containing the HAoR.

7. The lamp of claim 1, wherein the fastener is a clip engaged with the housing and extends below the housing to contact the bottom surface of the brim of the hat, and wherein the HAoR is in a horizontal plane above the top surface of the brim of the hat.

8. The lamp of claim 7, wherein while the first optical axis is horizontal the first optical axis is in a horizontal plane above the HAoR and below the plane of the solar panel.

9. The lamp of claim 1, further comprising a second light emitter held by the rotatable member and having a second optical axis.

10. The lamp of claim 9, wherein the while the first optical axis is horizontal and the second optical axis is horizontal, the first optical axis is in a horizontal plane higher than the horizontal plane containing the HAoR, and the second optical axis is in a horizontal plane lower than the horizontal plane containing the first optical axis.

11. The lamp of claim 9, wherein the second optical axis is not parallel to the first optical axis of the first light emitter.

12. The lamp of claim 1, further comprising a third light emitter having a third optical axis configured to rotate about the HAoR independently of the rotation of the first light emitter about the HAoR.

13. The lamp of claim 1, further comprising a mode-selection switch configured to control the ON/OFF state of the first switch.

14. The lamp of claim 13, further comprising an integrated circuit including the first switch, wherein the mode-selection switch is connected to the control gate of first switch through the integrated circuit.

15. The lamp of claim 1, further comprising:
a second light emitter held by the rotatable member and having a second optical axis;
a second switch for controlling the second light emitter configured to be connected in series between the rechargeable battery and the second light emitter, wherein the mode-selection switch is configured to control the ON/OFF state of the second switch; and
an integrated circuit including the first switch and the second switch, wherein the mode-selection switch is connected through the integrated circuit to the control gate of first switch and to the control gate of the second switch.

16. The lamp of claim 1, wherein the fastener is an elastic clip engaged with the housing and extends below the housing to contact the bottom surface of the brim of the hat.

17. The lamp of claim 16, wherein the clip is positioned engaged with the housing so that HAoR is at least 4 millimeters forward of the forward edge of the brim while attached to the brim.

18. The lamp of claim 1, wherein the HAoR contains at least one point within 3 millimeters of a bottom exterior surface of the rotating member.

19. A lamp for engagement with a brim of a hat, comprising:
a housing including a main body including a chamber configured for containing a battery;
a first hinge on the front side of the housing and having a horizontal axis of rotation (HAoR) in a plane less than 4 millimeters above the top surface of the brim while the main body is attached to the brim;
a first rotatable member, holding a first light emitter having a first optical axis, that rotates about the HAoR;
a first switch for controlling the first light emitter and configured to be connected in series between the battery and the first light emitter; and
a clip for removably attaching the housing to the brim of the hat, wherein the clip is positioned engaged with the housing so that HAoR is at least 4 millimeters forward of the forward edge of the brim while attached to the brim.

20. The lamp of claim 19, a second hinge on the front side of the housing and having the same horizontal axis of rotation (HAoR) wherein the first rotatable member is disposed between the first hinge and the second hinge, and wherein the first hinge includes a first hollow hinge pin and wires that are connected in series with the first light emitter and extend through a passage through the first hollow hinge pin.
